(19) United States
(12) Patent Application Publication
(10) Pub. No.: US 2011/0113230 A1
(43) Pub. Date: May 12, 2011

(54) APPARATUS AND METHOD FOR SECURING AND ISOLATING OPERATIONAL NODES IN A COMPUTER NETWORK

(76) Inventor: Daniel Kaminsky, Seattle, WA (US)

(21) Appl. No.: 12/944,590

(22) Filed: Nov. 11, 2010

Related U.S. Application Data
(60) Provisional application No. 61/281,114, filed on Nov. 12, 2009.

(51) Int. Cl. G06F 9/06

(52) U.S. Cl. 713/2

(57) ABSTRACT

A system and method for securing firmware from malware in a computer processing system having a trusted node daughterboard connected to at least one operational node motherboard. The method includes the steps of sending a power on signal from the trusted node daughterboard to the operational node motherboard when it is desired to utilize the operational node motherboard for computer processing purposes. Pre-boot data is then requested from the operational node motherboard and is sent from the trusted node daughterboard to the operational node motherboard to enable operation of the operational node motherboard.

### CROSS REFERENCE TO RELATED APPLICATIONS

This application claims the benefit of U.S. Provisional Patent Application 61/281,114 entitled SYSTEM AND METHOD FOR PROVIDING SECURE VIEWING OF TRANSMITTED DATA, by Daniel Kaminsky, filed Nov. 12, 2009, the entire contents of which are incorporated herein by reference.

This application is related to the following commonly owned, co-pending United States patents and patent applications, each of which are incorporated by reference herein in their entirety:

United States patent application No. ______ entitled SYSTEM AND METHOD FOR PROVIDING SECURE RECEPTION AND VIEWING OF TRANSMITTED DATA OVER A NETWORK, by Daniel Kaminsky, filed Nov. 11, 2010 (Attorney Docket No. 1300.02).

United States patent application No. ______ entitled METHOD AND APPARATUS FOR SECURING NETWORKED GAMING DEVICES, by Daniel Kaminsky, filed Nov. 11, 2010 (Attorney Docket No. 1300.04).

### FIELD OF THE INVENTION

This invention generally relates computer network security, and more specifically to a system for isolating operational network nodes from potential malware attacks propagated over a computer network.

### BACKGROUND

As more and more computers are interconnected through various networks, such as the Internet, computer security has become increasingly important, particularly from invasions or attacks delivered over a network or over an information stream. Such attacks can come in many different forms, such as computer viruses, computer worms, system component replacements, denial of service attacks, and general misuse/abuse of legitimate computer system features, all of which exploit one or more computer system vulnerabilities for illegitimate purposes. While these various computer attacks may be technically distinct from one another, for purposes of the present description, all of these attacks and other similar attacks will be generally referred to hereafter as “computer malware”, or more simply “malware”.

When a computer system is attacked or “infected” by malware, the adverse results are varied, including disabling system devices; erasing or corrupting firmware, applications, or data files; transmitting potentially sensitive data to another location on the network; shutting down the computer system; or causing the computer system or applications to crash. Another effect of computer malware is that an infected computer system can be used to infect other computers.

An example networked environment over which computer malware is commonly distributed typically includes a plurality of coupled computers, all interconnected via a communication network, such as an intranet, or a larger communication network, including the global TCP/IP network commonly referred to as the Internet. For whatever reason, a malicious party on a computer connected to the network may develop computer malware and release it on the network. Once received, the released malware then infects one or more other networked computers. Each of these computers may then be used to infect other computers, and so on. Due to the speed and reach of the modern computer networks, the spread of computer malware can grow at an exponential rate and quickly become a local epidemic that quickly escalates into a global computer pandemic.

A traditional defense against computer malware and, particularly computer viruses and worms, is antivirus software. Generally, antivirus software scans incoming data arriving over a network, looking for identifiable patterns associated with known computer malware. Frequently, this is done by matching patterns within the data to what is referred to as a “signature” of the malware. One of the core deficiencies in this malware detection model is that the new malware is constantly being generated before antivirus definitions can be created, thus an unknown computer malware may propagate unchecked in a network until a computer's antivirus software is updated to identify and respond to the new computer malware.

As antivirus software has become more sophisticated and efficient at recognizing thousands of known computer malware, so too has the computer malware become more sophisticated. For example, many recent computer malware programs are polymorphic. Such polymorphic malware is frequently difficult to identify by antivirus software because the programs can modify themselves before propagating to another computer. Thus, under present systems there is a period of time, referred to as a vulnerability window, that exists between when a new computer malware program is released on a network and when a computer system is updated to protect itself from the malware. As the name suggests, it is during this vulnerability window that a computer system is most at risk to being exposed to and infected by the new computer malware.

Furthermore, antivirus software typically only seeks to protect certain memory storage components on a computer system, such as the on-board hard drive (HDD) and/or solid state disc (SSD) components. However, there are often other persistent storage components on a computer which are not under the protection of antivirus software, such as the motherboard BIOS, network card firmware and even the microcontroller firmware storage components. As malware attackers have become more sophisticated, they are now looking to these unprotected persistent storage components to place malware, which can result in the entire computer system becoming permanently comprised in a stealthy manner.

### SUMMARY OF THE INVENTION

Embodiments are described for a system and method for securing firmware from malware in a computing system having a trusted node connected to at least one operational node. The method comprises the steps of sending a power up signal from the trusted node to the operational node when it is desired to utilize the operational node for computer processing purposes, requesting from the trusted node pre-boot data from the operational node, and sending pre-boot data from the trusted node to the operational node. Upon completion of the desired computer processing on the operational node, the trusted node causes the operational node to reboot to remove the pre-boot data and the operating system software from the operational node such that no rewrite functions are performed on the operational node.

Embodiments also include a method and system for securely opening a data file in a computer processing environment having a trusted node daughterboard connected to at least one operational node motherboard with an e-mail (electronic mail) processing system operatively coupled to the trusted node daughterboard. The method includes the steps of when a data file is to be opened, sending a power on signal from the trusted node daughterboard to the operational node motherboard when it is desired to utilize the operational node motherboard for opening a data file. Pre-boot data is then requested from the operational node motherboard and is sent from the trusted node daughterboard to the operational node motherboard to enable operation of the operational node motherboard for securely opening a data file.

After the e-mail attachment has been opened by the operational node motherboard and made accessible to an intended recipient, a power-off signal is sent from the trusted node daughterboard to the operational node motherboard to wipe clean any malware that may have comprised it from opening the previous data file. The operational node motherboard is then in an off and clean state awaiting another execution command from a trusted node daughterboard.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a functional block diagram of an example of a processing system that can be utilized to embody or give effect to a particular embodiment of the present invention;

FIG. 2 illustrates an embodiment of a split brain design of the present invention in which a trusted daughterboard is connected to a management network operative to manage an operational motherboard.

FIG. 3 illustrates a network implementation of the split brain computer system of FIG. 2 under an embodiment.

FIG. 4 represents an example cloud computing system that implements embodiments of the split brain system of FIG. 3.

FIG. 5 illustrates an electronic mail system that implements embodiments of the present invention.

FIG. 6 is a flowchart that illustrates a process of processing e-mail messages in the system of FIG. 5, under an embodiment.

FIG. 7 is a flow diagram that illustrates the power cycle and bootstrap processing acts performed to remove potential malware infections, under an embodiment.

FIG. 8 is a timeline illustrating the elimination of a malware infection by the process of FIG. 7, under an embodiment.

### INCORPORATION BY REFERENCE

All patents and patent applications that are referenced herein are hereby incorporated by reference in their entirety.

### DETAILED DESCRIPTION

Embodiments of the present invention broadly relate to problems associated with persistent data storage in computing nodes. For instance, such storage can take place in: on-board hard drives, solid state discs (SSD), motherboard BIOS, network card firmware and microcontroller firmware. Such persistent storage provides opportunities for malware to reside in one or more of the aforesaid components, and, once stored in any one of these components, the operability of the entire associated system is significantly compromised due to the presence of such malware.

For purposes of the present description, the term “malware” is to be understood to represent malicious software, which is software designed to infiltrate or damage a computer system without owner permission. The expression is a general term used by computer professionals to mean a variety of forms of hostile, intrusive, or annoying software or program code. The term “computer virus” is sometimes used as a catch-all phrase to include all types of malware, including viruses. In general, software is considered malware based on the perceived intent of the creator rather than any particular features, and may include computer viruses, worms, trojan horses, most rootkits (a software system that consists of a program or combination of several programs designed to hide or obscure the fact that a system has been compromised), spyware, dishonest adware, crimeware and other malicious and unwanted software. Malware does not necessarily include defective software, which is software that has a legitimate purpose but contains harmful bugs.

It is to be appreciated that while the illustrated embodiments of the present invention may be discussed in reference to “cloud computing”, the present invention system and method is not to be understood to be limited thereto as it is to be understood to encompass all computer networks and environments that may be exposed to malware.

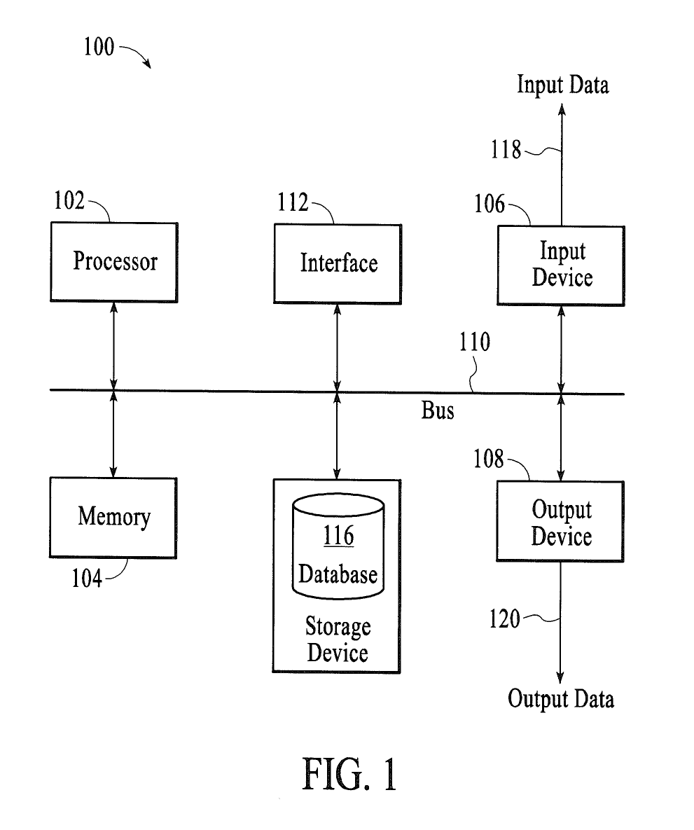

FIG. 1 depicts an example general-purpose computing system in which embodiments of the present invention may be implemented. As shown in FIG. 1, computer system 100 generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI (peripheral component interconnect) card or PC card. At least one storage device 114 which houses at least one database 116 can also be provided. The memory 104 can be any form of memory device, for example, volatile or non-volatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, and so on. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, and so on. Output data 120 could be distinct and derived from different output devices, for example a visual display on a monitor in conjunction with data transmitted to a network. A user could view data output, or an interpretation of the data output, on an external device, such as a display monitor or a printer. The storage device 114 can be any form of data or information storage means, for example, volatile or non-volatile memory, solid state storage devices, magnetic devices, and the like.

In use, the processing system 100 is adapted to allow data or information to be stored in and/or retrieved from, via wired or wireless communication means, at least one database 116. The interface 112 may allow wired and/or wireless communication between the processing unit 102 and peripheral components that may serve a specialized purpose. Preferably, the processor 102 receives instructions as input data 118 via input device 106 and can display processed results or other output to a user by utilizing output device 108. More than one input device 106 and/or output device 108 can be provided. It should be appreciated that the processing system 100 may be any form of terminal, server, specialized hardware, or the like.

It is to be appreciated that the processing system 100 may be a part of a networked communications system. Processing system 100 could connect to a network, for example the Internet or a WAN. Input data 118 and output data 120 could be communicated to other devices via the network. The transfer of information and/or data over the network can be achieved using wired communications means or wireless communications means. A server can facilitate the transfer of data between the network and one or more databases. A server and one or more databases provide an example of an information source.

Thus, the processing computing system environment 100 illustrated in FIG. 1 may operate in a networked environment using logical connections to one or more remote computers. The remote computer may be a personal computer, a server, a router, a network PC (personal computer), a peer device, or other common network node, and typically includes many or all of the elements described above. The remote computer may also be embodied in a mobile processing or communication device, such as a laptop/notebook computer, PDA (personal digital assistant), smartphone, or other similar processing device.

It is to be further appreciated that the logical connections depicted in FIG. 1 include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the computing system environment 100 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100, or portions thereof, may be stored in a remote memory storage device. It is to be appreciated that the illustrated network connections of FIG. 1 are exemplary and other means of establishing a communications link between multiple computers may be used.

FIG. 1 is intended to provide a brief, general description of an illustrative and/or suitable exemplary environment in which embodiments of the below described present invention may be implemented. FIG. 1 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1. As such, it will be understood that such acts and operations, which are at times referred to as being computer-implemented or computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, smartphones, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

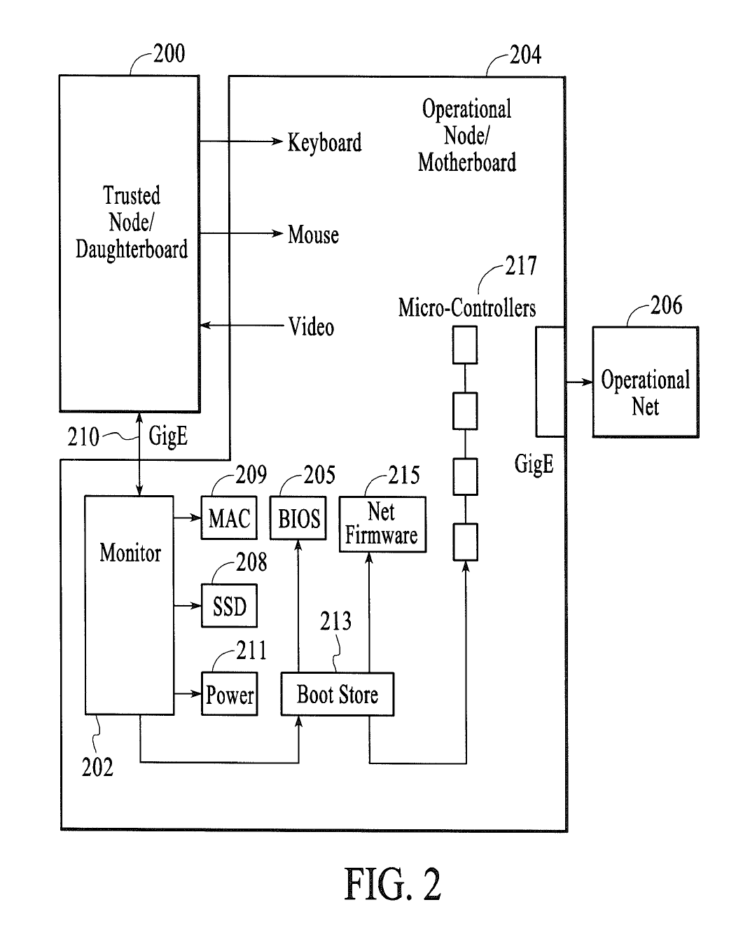

Embodiments of the computing system environment 100 of FIG. 1 are used to implement aspects of a computer architecture, sometimes referred to as a “split brain” design in which a daughterboard is used to manage and isolate an operational motherboard on a networked computer during the transfer of data over the network. FIG. 2 illustrates an embodiment of a split brain design of the present invention in which a trusted daughterboard 200 (trusted node) is connected to a management network operative to manage an operational motherboard 204 (operational node), which is preferably connected to an operational network 206.

To reduce vulnerability to malware attacks it is advantageous to minimize as much as possible, the amount of persistent storage on an operational node. However, eliminating persistent storage from an operational node to obviate malware infection requires novel solutions not found or taught in the prior art. It is generally understood that a purpose of having numerous components on an operational node retain data across reboot is to enable basic functioning of the operational node. For instance, typically microcontrollers do not function properly, or at all, without any firmware. Embodiments of the present invention eliminate persistent storage from an operational node by deploying, preferably in ROM (Read Only Memory), “stub firmware” that either retrieves or receives its normal boot state from a centralized buffer on the operational node. As shown in FIG. 2, a dedicated Gigabit Ethernet interface 210 is employed to provide such a centralized buffer with its state information, from which the system may retrieve fresh copies of its motherboard BIOS, network card firmware, and microcontroller firmware from the trusted node during a pre-boot sequence. It is noted that a Gigabit Ethernet interface (GigE) is generally preferred for enabling connectivity between a trusted node and operational nodes because a GigE interface does not discriminate between the data packets sent to it as it has no inherent connectivity. In general, GigE refers to a transmission standard as defined by IEEE 802.3-2008. It should be noted, however, that other similar transmission standards and corresponding interfaces can also be used.

To ensure further security for the computing system environment, the power on/off commands are preferably implemented through dedicated, maximally-isolated hardware, as opposed to a conventional IPMI (Intelligent Platform Management Interface) BMC (baseboard management controller) mechanism. Such an arrangement prevents the canonical attack of a reboot/refresh cycle being suppressed within compromised hardware, which could pretend to have loaded clean firmware on an operational node.

For the system of FIG. 2, when properly configured it is virtually impossible to permanently write any data to any persistent storage source or component on the operational node 204 without administrator consent. This includes all BIOS 205, which represents boot firmware that is designed to be the first code run by a computer when powered on. The initial function of the BIOS 205 is to identify, test, and initialize system devices such as the video display card, hard disk, other disk sources and hardware. Typically, this process places the computer into a known state, so that any software stored on compatible media can be loaded, executed, and given control of the computer. This process is commonly known as booting or booting up, and otherwise known as bootstrapping. BIOS programs are typically stored on a chip and are built to work with various devices that make up the complementary chipset of the overall system. They provide a small library of basic input/output functions that can be called to operate and control the peripherals such as the keyboard, text display functions and so forth.

For the system of FIG. 2, it may still be possible to permanently write storage data on the SSD 208 of the operational node 204, since the SSD 208 may be considered temporary storage. The operational node 204 may also include a standard VGA output (wherein the VESA-DDC pins are preferably blocked), USB ports, a GigE interfacing network 210 and hardware virtualization support.

The illustrated embodiment of FIG. 2 of the present invention is operative such that the trusted node 200, via GigE 210, manages the content of all persistent data stores (including the SSD 208) present on the operational node 204. Additionally, the trusted node 200 is configured and operative to power on and off the operational node 204, preferably via the GigE interfacing connection 210, whereby it is virtually impossible to cause unintended power issues for the trusted node 200 from the operational node 204. With regard to the power management of operational nodes, the system architecture illustrated in FIG. 2 renders it virtually impossible for an operational node to adversely impact power flow to trusted nodes.

As shown in FIG. 2, the trusted node 200 is coupled to the operational node 204 through a monitor component 202. The monitor 202 is a multiport switch that may include some degree of processing capability or circuit logic to perform tasks such as packet analysis. The monitor can be configured to detect power messages and other out-of-band critical messages from the trusted node 200 and deliver them to appropriate points on the operational node 204. It can also be configured to see frames transmitted from the operational node 204 to the trusted node 200 and perform any appropriate MAC (media access control) 209 filtering. For the embodiment of FIG. 2, the monitor component 202 is also functionally coupled to the power circuit (on/off switch) 211 and boot store 213 of the operational node 204. The boot store 213 is used to control the net firmware component 215 and any micro-controller units 217 that may be present on the operational node 204.

In an embodiment, the trusted node 200 is configured and operational to disable or fully wipe (delete all storage) on the SSD 208 of the operational node 204. The trusted node 200 is preferably operational to reset the operational node 204 in a relatively brief time period (e.g., approximately 15 seconds or less) when the purpose of use for the operational node 204 has been completed.

The illustrated embodiment of FIG. 2, may be further configured such that the trusted node 200 is provided support for a conventional x86 processor, PS/2 keyboard and mouse peripheral components. It is noted that in accordance with the present invention, there is preferably no actual persistent storage on the operational node 204 aside from the SSD 208. Thus, to accomplish this, rather than blocking writes, a “pre-boot” load of firmware may be implemented. Also, in accordance with embodiments, the maximum performance-per-watt on the central processing unit (CPU) for the operational node 204 is accomplished along with the provision of sufficient RAM storage parameters. Further, support is provided for a hardware “freeze/resume” command, from the trusted node 200 to the operational node 204 and for resetting the operational node 204 to a known good state in preferably less than one second when desired. Additionally, with respect to actual implementation details, a USB (Universal Serial Bus) boot structure is preferably provided on the trusted node 200, and instead of one node per 1 U space, the illustrated embodiment of FIG. 2 of the present invention preferably utilizes a blade architecture with a locked down backplane.

In general, the daughterboard and motherboard of the split brain architecture can be embodied in separate component boards that are coupled to one another through physical connectors, cables, ribbon cables, bus wiring, or other connection means as is known in the electrical manufacturing art. For example, the daughterboard may be embodied in a physical circuit board that is inserted in the motherboard by means of a physical interface connector that physically and electrically couples the two boards. The boards may also instead be coupled to one another through a ribbon cable or bus wiring connection that provides an electrical connection, but not a rigid physical connection. In alternative embodiment, the daughterboard in logic circuitry that is implemented in a device or component that is mounted on a motherboard, such as through a chip carrier or similar mechanism. In yet a further alternative embodiment, the daughterboard and motherboard functions may be provided in different circuits on the same board, or on a hybrid component board.

In an embodiment, the system of FIG. 2 may utilize an IP KVM structure on the trusted node 200, whereby video, keyboard, and mouse commands are routed back to the trusted node 200 as opposed to being routed back to a traditional IP KVM hardware component. The IP KVM (Internet Protocol, Keyboard/Video/Mouse) component or switch is generally a hardware device that enables a user to control from a single keyboard, video monitor and/or mouse, the keyboards, video monitors and mouse components associated with multiple computers.

The illustrated embodiment of FIG. 2 of the present invention may be yet further configured to include a hardware key cycler for SSD 208, which irrevocably destroys encryption keys for SSD content between boots. An IP firewall may also be provided in front of the operational motherboard GigE interfacing port 210. Also, the functionality of having the ability to monitor IP traffic on the operational nodes GigE interfacing port 210 from the trusted node 200 may be provided as well as the ability to Remote Direct Memory Access (RDMA) from the trusted node 200 to the operational node 204 via a private GigE interfacing link. In general, RDMA is a direct memory access from the memory of one computer into that of another without involving either computer's operating systems. This permits high-throughput, low-latency networking, which is especially useful in massively parallel computer clusters. Typically, RDMA supports zero-copy networking by enabling the network adapter to transfer data directly to or from application memory, eliminating the need to copy data between application memory and the data buffers in the operating system. Such transfers require no work to be done by CPUs, caches, or context switches, and transfers continue in parallel with other system operations. When an application performs an RDMA Read or Write request, the application data is delivered directly to the network, reducing latency and enabling fast message transfer. Thus, by providing the ability to RDMA from the trusted node 200 to the operational node 204 via a private GigE interface, it is virtually impossible to permanently damage (corrupt) the operational node 204 with any external electrical manipulation/illegal read or write commands.

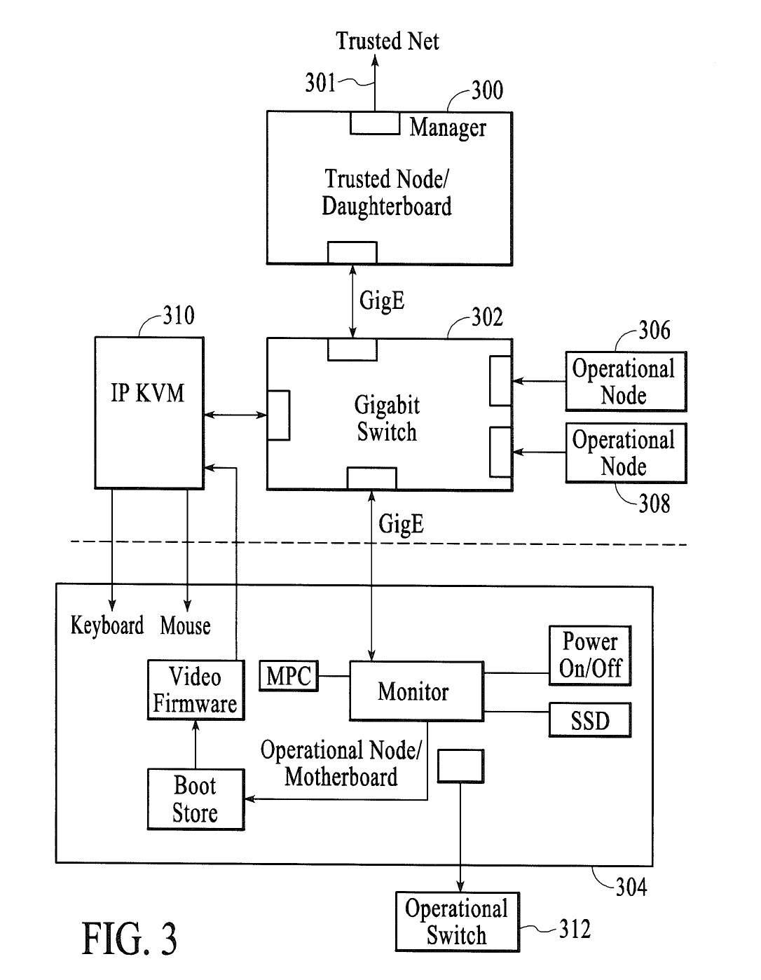

FIG. 3 illustrates a network implementation of the split brain computer system of FIG. 2 under an embodiment. As shown in FIG. 3, a trusted node daughterboard 300 is coupled to a trusted switch 302, which in turn is coupled to an operational node motherboard 304. Trusted node 302 is also shown coupled to a trusted network 301. Preferably, trusted switch 302 is a Gigabit Ethernet switch having Gigabit Ethernet connections to the trusted node 300 and operational node 304. It is to be appreciated that trusted switch 302 may be coupled to a plurality of operational node motherboards, such as nodes 306 and 308. Trusted switch 302 is also preferably coupled to an IP KVM component 310, which in turn is coupled to the operational node 304. Operational node 304 may also be coupled to an operational switch 312.

The IP KVM 310 is preferably operational to provide input commands (e.g., keyboard and mouse) from trusted node 300 to operational node 304, through trusted switch 302. Additionally, IP KVM 310 is operational to provide video output information from operational node 304 to trusted node 300 also through trusted switch 302.

As mentioned above with reference to FIG. 2, trusted node 300 controls the on/off functionality of operational node 304 as well as provides the preboot data and operating system software to the data storage components found on operational node 300. Additionally, firewalling of the IP packets sent from the operational node 302 may be provided for further security if so desired.

The embodiment of FIG. 3 provides the fundamental advantages of preventing unauthorized hardware writes while providing a fully manageable cloud node (i.e., operational motherboard/node) while at all times preventing the cloud management layer from being corrupted with malware or other malicious actions. This advantage is accomplished by providing the illustrated split brain architecture in which a primary operational motherboard/node is operatively coupled to a secondary trusted daughterboard/node, in which the purpose of the primary operational motherboard is to provide the maximum performance per watt, while always being able to be reset into a known-good state. The purpose of the secondary trusted daughterboard/node is to store and manage that state of the operational motherboard/node, preferably using information bootstrapped from the internet cloud.

Using present described embodiments, a computing cloud may be set up with both trusted and operational networks/nodes, exposing two GigE interfacing ports to each node. Preferably one GigE port is connected to the trusted node 300, containing: an x86 operating environment, a BIOS capable of netbooting, persistent storage for trusted state and bootstrapping data and a connection to the operational motherboard/node 304. Each operational motherboard/node in the split brain architecture is a relatively standard x86 motherboard, tuned to offer maximum performance-per-watt having a connection to the trusted daughterboard/node with an on-board video out (having preferably the VESA-DDC disabled). Preferably also provided are a PS/2 keyboard and mouse and IP KVM access preferably implemented with either a standard rackmount IP KVM configured to operate over a PS/2 or an IP KVM integration with the trusted daughterboard/node. Also preferably additionally provided is a temporary SSD, which either 1) has a hardware key cycler, that renders content from a previous boot unreadable to future ones (thus obviating the need to clear the drive between boots), or 2) requires software to implement the this key cycler functionality. Further provided is a GigE connection to the operational network, hardware virtualization support in the CPU, sufficient RAM and control over unauthorized hardware writes.

It is to be appreciated that while some components on an operational node do not have persistent storage capabilities, many do thus causing the PC components on the operational node to be susceptible to malware attacks. For instance, many components have internal firmware in flash, especially when microcontrollers are taken into account. Thus, an unauthorized write to this flash memory can create a permanent, persistent infection that is difficult, or impossible, to clean. Therefore, in accordance with certain embodiments, there are four strategies that can manage these flash memory components. The first is to replace the flash ROM on the operational node with centralized RAM that is populated by the secure daughterboard in a pre-boot sequence. The second is to replace the flash ROM on the operational node with fixed ROM. This may sacrifice some degree of updatability on components, however such components may actually only be rarely patched, if at all. The third strategy is to manage the flash ROM from the daughterboard, using hardware control pins to “lock” access to the flash ROM unless the trusted daughterboard explicitly enables writeability. The fourth strategy is to manage the flash ROM with code in the firmware that only allows updates that match specific cryptographic assertions.

Embodiments of the present invention also include mechanisms to prevent corruption or attack on the trusted node. There are two methods to establish connectivity between the trusted node (the daughterboard) and the operational node (the motherboard) to prevent the backflow of information from the operational node to the trusted node to prevent an operational motherboard/node under the control of the attacker from corrupting the trusted network. A first method is the implementation of a relay approach whereby relays are set up to make certain components (e.g., RAM, SSD) appear in one environment or the other, but not both. With the relay method, pre-boot data is copied onto various persistent stores that are then “swapped” into the operational core. This does not require any specialized software or firmware, nor any parsing on the trusted node of content from the operational node.

The second method is a networking approach whereby a private GigE connection is established between the motherboard and the daughterboard in which the motherboard loads content via the daughterboard. In this networking approach, the backflow of information is prevented from the operational node to the trusted node in which the trusted node can read and write arbitrary memory of the guest, which can be advantageous. For instance, provided is the ability to enable a rapidly cycled filter for untrusted content preferably providing the functionality to snapshot and “return to known good state” the operational motherboard rapidly (such as at least as fast as a VMware restore operation). Therefore, regardless how the bulk state is managed between the trusted and operational nodes, preferably at least one set of control pins will be required; for example, the trusted daughterboard/node will be configured and operative to power on and power off the operational motherboard.

It is to be appreciated that further hardware may be provided to limit the amount of firewalling on the IP packets originating from operational node. In particular, hardware may be provided to enable a trusted node to declare an IP, a set of IPs, or an IP range, for the operational nodes that the GigE interface is to use.

Embodiments of the trusted node/operational node split brain system can be implemented in wide variety of operational environments that implement or control LAN or WAN communications. A typical operational implementation may be the deployment of multiple split brain operational nodes in a rack mount system that includes several other network and controller boards. Such a system might comprise a Trusted Manager board, an IP KVM board, an L3 switch board, and a number of operational node boards each implementing a split brain architecture as described above. The L3 (Layer 3) switch operates as a network router and can be configured to inspect incoming packets and make dynamic routing decisions based on the source and destination addresses.

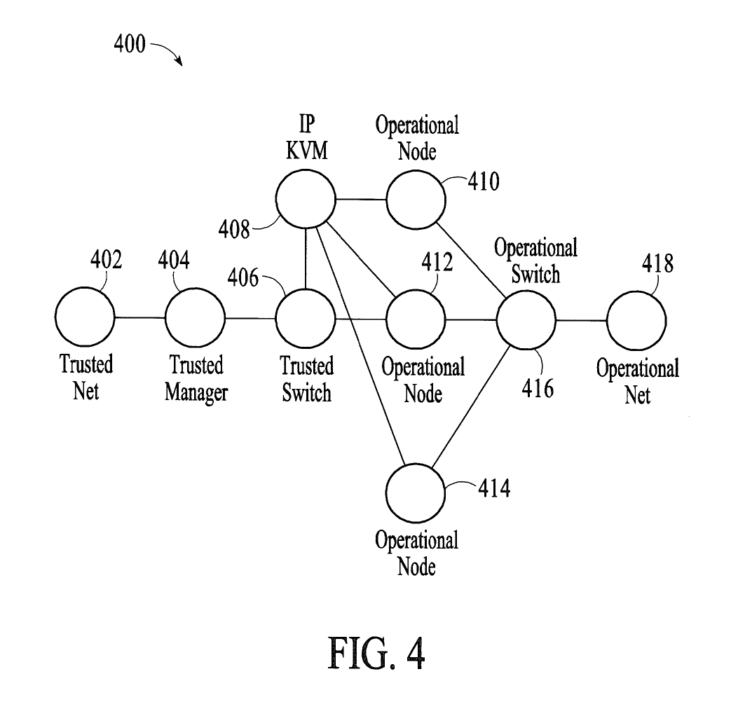

FIG. 4 represents an example cloud computing system that implements embodiments of the split brain system of FIG. 3. As shown in FIG. 4, a trusted net 402 is coupled to a trusted manager 404, which in turn is coupled to a trusted switch 406. Trusted switch 406 is coupled to an IP KVM controller 408. Both trusted switch 406 and IP KVM 408 are each coupled to operational nodes 410, 412 and 414. An operational switch 416 is also coupled to operational nodes 410-414, and to trusted net 402.

A normal method of operation of system 400 is as follows: each operational node 410-414 is in an off state but is listening for Wake-On LAN packets from a trusted switch 406. When the internet cloud 402 desires to activate an operational node 410-414, it sends a packet to the node's management interface (trusted manager 402) instructing it to enter pre-boot mode. A small computational environment is activated on the selected operational node 410-414, which retrieves a full copy of the boot store from the trusted manager 404 via the trusted switch 406 so as to prevent operational nodes 410-414 from spoofing the IP/MAC of the trusted manager 404. Preferably, all components in the activated operational node 410-414 receive or retrieve their packets of the boot store from the trusted manager 404 wherein RAM is preferably wiped clean to avoid malware attacks. Next, the activated operational node boots up normally, and immediately netboots off via a coupled management interface. The management interface boots a stub operating system, which populates the SSD of the activated operational node with the required software and data. Afterwards, the stub operating system of the activated operational node declares itself loaded, and sends the lock code to the SSD so the stub operating system can now boot from the write-locked SSD of the activated operational node. After a predetermined passage of time, an administrator administers the cloud node by connecting the activated operational node to the IP KVM 408, which preferably has unidirectional video coming into it and a unidirectional PS/2 keyboard and mouse (as described above). Once the internet cloud 402 wishes to repurpose the activated operational node 410-414, preferably any soft shutdown tasks are executed via normal software layers, and then a hard power off packet is sent. Once the hard power off message is received, the operational node is powered down at the hardware level. Since there is no persistent data that an attacker could have changed, anything malware on the operational node is erased.

Embodiments of the present invention are applicable to a number of different network based applications involving transmission of data among networked computers. One of the most popular network applications, and one of the most dangerous with respect to malware transmission and propagation, is the transmission of electronic mail through LAN and WAN systems.

### Electronic Mail Application

Electronic mail (“e-mail”) has become a ubiquitous form of communication in recent years. In general, e-mail works as follows: e-mail software (an “e-mail client”) is installed on client device, e.g., a personal computer (PC), equipped or configured for communications with a multiplicity of other client devices via a communications network. Access to the communications network can be provided by a communications network service provider, e.g., an Internet Service Provider (ISP) and/or a proprietary network e-mail service provider, with whom the user establishes one or more e-mail accounts, each identified by a unique e-mail address, e.g., president@whitehouse.gov. The e-mail software, e.g., the e-mail client, enables a user of the client device to compose e-mail messages, to send e-mail messages to other client devices via the communications network, and to read e-mail messages received from other client devices via the communications network. A user can send e-mail messages to multiple recipients at a time, which capability is sometimes referred to using a mailing list or, in extreme cases, bulk mailing. The typical e-mail client supports Post Office Protocol Version 3 (POP3), Simple Mail Transfer Protocol (SMTP), Internet Mail Access Protocol, Version 4 (IMAP4), and/or Multipurpose Internet Mail Extensions (MIME).

Each ISP and each proprietary network e-mail service provider independently operates and controls an e-mail communication system (or, simply, “e-mail system”). These independently-operated e-mail systems are bi-directional store-and-forward communication systems that are interconnected to one another via the Internet. Each e-mail system generally includes a number of e-mail servers that store inbound and outbound e-mail messages and then forward them, route them, or simply make them available to the users/intended recipients. In other words, an e-mail server is an application that receives incoming e-mail from users and outside senders and forwards e-mail for delivery. A computer dedicated to running this type of application is called a mail server. Microsoft Exchange, qmail, Exim, postfix and sendmail are some of the basic email programs.

Different e-mail systems are operated and controlled by independent control entities. With the advent of the Internet, the user is not restricted to a single system providing both an incoming e-mail server (or server cluster) and an outgoing e-mail server (cluster), i.e., both the incoming and outgoing e-mail servers under the control of a single entity. Most e-mail clients can be configured to receive e-mail from an incoming e-mail server (cluster) controlled by a first entity and an outgoing email server (cluster) controlled by a second, totally independent entity. It will be appreciated that most casual email users download from and upload to respective servers operated by a single entity.

Generally, when a user desires to send e-mail messages, or to check for received messages (which operations can occur automatically according to a prescribed schedule), the e-mail software is activated. Upon being activated, the e-mail software performs the following tasks: (1) effects a connection or communications session with the host ISP or e-mail service provider via a prescribed communication link by invoking a prescribed communications mechanism, e.g., a dial-up modem, an ISDN connection, a DSL or ADSL connection, and so on; (2) electronically transmits or transports any e-mail messages desired to be sent to the e-mail server system operated by the host ISP or e-mail service provider, e.g., via an SMTP server; (3) receives any inbound e-mail messages forwarded to the client device by the host ISP or e-mail service provider, e.g., via a POP3 or IMAP4 server; and (4) stores any received e-mail messages in a prescribed memory location within the client device, e.g., at either the default location established by the e-mail client or a user-selected location.

It is to be appreciated that once such prior art e-mail systems became exposed to malware, typically via email attachments, the malware could spread to the numerous persistent memory storage sources and locations associated with the e-mail system creating a compromising situation for the e-mail system and the intended recipient computing system. Embodiments include a method to transcode mail attachments from an existing and potentially dangerous or vulnerable form (e.g., Adobe PDF, Office Document) into safely parseable image formats. These image formats are then aggregated to provide a near-pixel equivalent display to the user. In a normal application, a centralized transcoding process would not necessarily eliminate all risk, instead the malware would end up compromising not just one user's documents, but every document sent in for conversion. Using the trusted node/operational node system, however, the operational node can be wiped clean in-between document conversations. Thus, if an attacker does infiltrate a document, any malware will be wiped out, with the only outflow of data from the system being a series of bitmaps. The output bitmaps are not only much easier to parse, but can be are aggregated into PDF files that can be displayed to the user.

Embodiments include a mechanism to transcode an input data file to another data format to facilitate the elimination of any malware associated with or embedded in the original data file. Transcoding generally refers to a process the direct digital-to-digital conversion of one encoding format to another and may involve the transformation of data or a file from one bitstream format to another without undergoing a complete decoding and encoding process. Typical examples of transcoding with respect to text data include the conversion of word processor files into .pdf format using a pdf (portable document format) conversion process.

In an embodiment, a plugin is implemented at the mail server, and parses each e-mail file as it arrives and then transforms the documents in situ. Alternatively, the plugin can be implemented in a mail client, detecting mails with attachments, forwarding the attachments to a configured conversion server, and displaying the results. Combination of mail server and mail client plugins can also be implemented. With regard to system output, the transcoder could provide pages inline with the document, since it has access to it as well as the main page. Alternatively, the transcoder could send bitmaps as a series of attachments. To reduce bandwidth use, the transcoder could attach a PNG (portable network graphics) file (or other similar compressed format file) composed of all of the PNG files.

While certain illustrated embodiments are described in reference to e-mail and e-mail attachments, such embodiments are not necessarily limited thereto. For instance, as one of ordinary skill in the art would readily recognize, the embodiments of the invention may be used with many data file formats where it is desirable to isolate the intended recipient from the actual data file while still being able to gain visual access to its contents, for security purposes as an example, such as when gaining access to a data file via a web browser interface. For instance, the data files may be any type of electronic document, image files, PDF files, e-mail, e-mail attachments, other types of image aggregated files, and the like. Therefore, it should be noted that the transcoding process described herein is not limited to e-mail attachments, but instead may be used in conjunction with virtually any other data communication application, such as a document archive process or a video file transcoding process, or other similar applications.

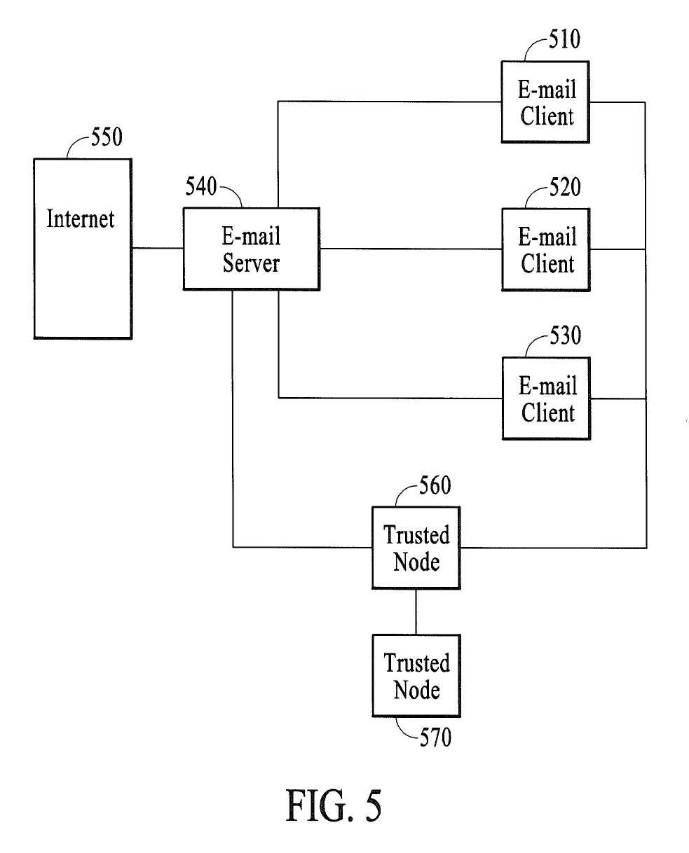

FIG. 5 illustrates an electronic mail system that implements embodiments of the present invention. As shown in FIG. 5, such an e-mail system is designated generally by reference numeral 500 and incorporates aspects that eliminate or significantly reduce disadvantages associated with prior art e-mail systems regarding the risk posed to them by malware. As illustrated, e-mail system 500 generally includes one or more e-mail clients 510-530 coupled to an e-mail server 540, which in turn, is directly or indirectly (e.g., through a firewall system) coupled to the Internet 550. E-mail server 540, or alternatively, each e-mail client 510-530, preferably includes a plugin module connecting it to a split-brain design computer system consisting of trusted node 560 and operational node 570. Such a trusted node 560 and operational node 570 split-brain system may conform to the embodiments illustrated and described with reference to FIGS. 2-4.

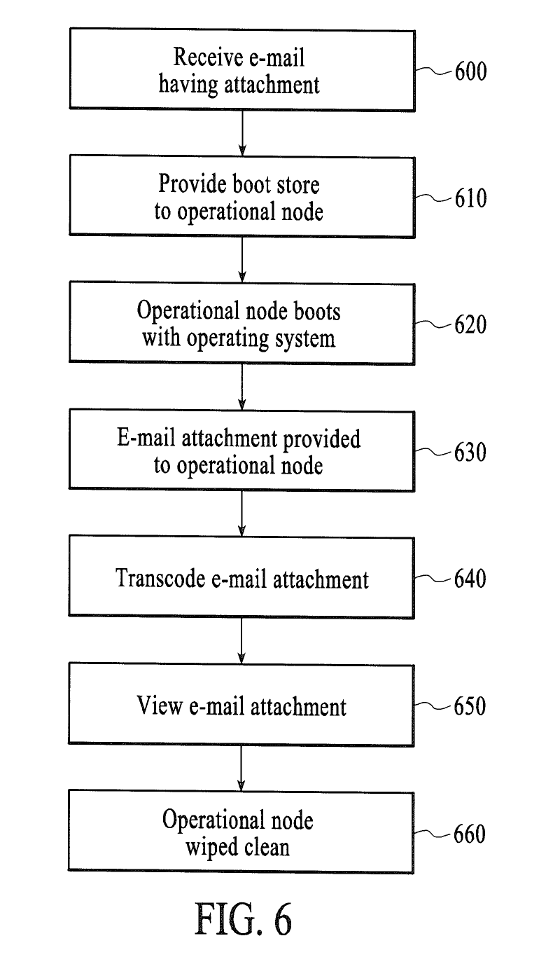

FIG. 6 is a flowchart that illustrates a process of processing e-mail messages in the system of FIG. 5, under an embodiment, and is described with respect to the components of FIG. 5. With reference to e-mail server 540 having a plugin module connecting to trusted node 560, its method of operation will be discussed with reference to FIG. 6. When an e-mail message is received in e-mail server 540 having an attachment (step 600), the plugin module of e-mail server 540 preferably instructs trusted node 560 to provide a boot store to operational node 570 (step 610). The operational node 570 then preferably boots with a stub operating system suitable to process the attachment associated with the aforesaid e-mail message resident in e-mail server 540 (step 620). The trusted node 560 then provides the e-mail attachment from e-mail server 540 to the operational node 560, preferably via an operational switch (step 630). Operational node 560 then opens the e-mail attachment and transcodes it from its existing relatively dangerous format (malware infected) into preferably a safely parseable image format, which can then be aggregated to provide a near-pixel equivalent (e.g., bitmaps) display to the user (step 640). The user of an intended e-mail client 510-530 then preferably safely views the aforesaid near-pixel equivalent of the attachment via an IPKVM component coupled to the operational node 570 (such as IPKVM 310) via a user display (step 650).

Alternatively in step 650 the operational node may be configured and operational to transform the near-equivalent image of the e-mail attachment into a document image aggregation formatted file, such as a PDF (portable data format) formatted document (or the like), which can then be sent to the user for safe viewing. In this manner, traditionally dangerous actions like automatic preview and open can become safe and even encouraged as the more secure method to process e-mail attachments.

After the e-mail attachment has been transcoded as described above by operational node 570, the trusted node 560 preferably wipes clean the operational node 570 such that any malware that may have been present in the e-mail attachment and possibly infected the operational node 570 during the transcoding process is now caused to be removed thus preventing it to cause the infection of any subsequent processing operations by operational node 570 (step 660).

The process of FIG. 6 may be repeated when alternatively the plugin module is implemented in an e-mail client 510-530 as opposed to an e-mail server 540, as described above. The principal difference being that the plugin module sends an attachment from an e-mail client 510-530 (as opposed to an e-mail server 540) to trusted node 560 for transcoding thereof.

It is to be appreciated that in another embodiment of the above described invention, the trusted node and operational node may be configured to form a single operational node operable as described with reference to operational node 570 wherein preferably it isolates the intended recipient (e.g., e-mail server 540, e-mail client 510-530, web browsers, File Transfer Protocol (FTP) sites, and other like means for sharing files) from the actual data file while still being able to gain visual access to its contents.

As stated previously, many prior art techniques for performing centralized transcoding actually do very little to eliminate the risk posed by e-mail attachments infected by malware, as the malware would end up not only comprising the intended recipient's documents, but every e-mail attachment that was to be transcoded in subsequent processes. However, in accordance with the embodiments of FIGS. 5-6, the operational node which performs the transcoding of the e-mail attachment is wiped clean between each e-mail transcoding process, thus subsequent e-mail attachment transcoding processes are not comprised by a preceding transcoding process.

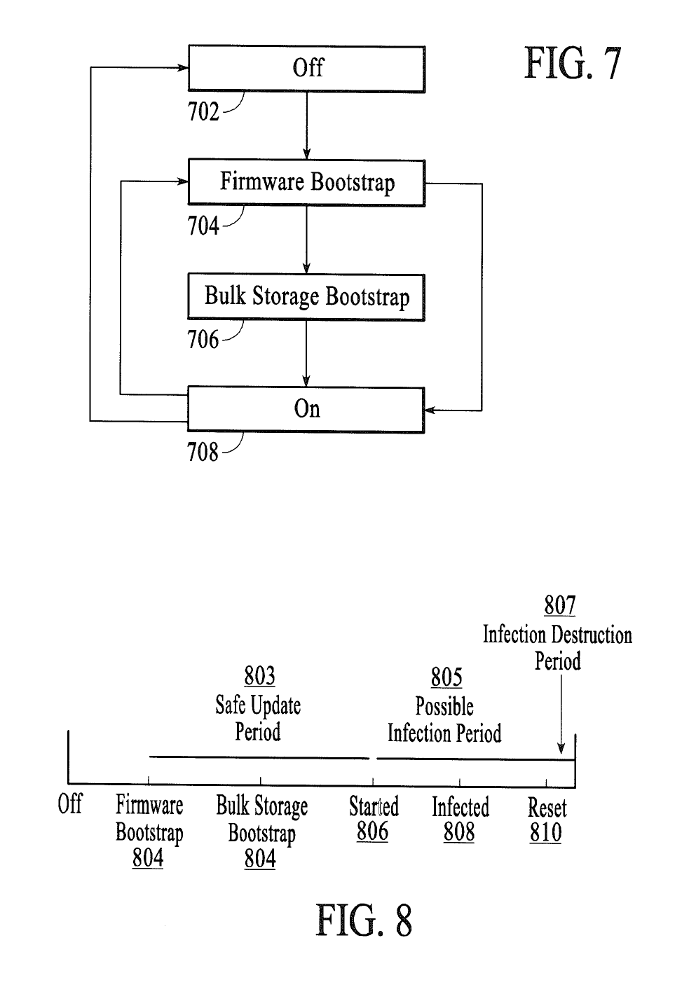

FIG. 7 is a flow diagram that illustrates the power cycle and bootstrap processing acts performed to remove potential malware infections in an e-mail transmission or other similar application, under an embodiment. FIG. 8 is a timeline illustrating the elimination of a malware infection by the process of FIG. 7, under an embodiment. As shown in FIG. 7, the operational node is initially in an off state 702, a firmware bootstrap process 704 turns the operational node on 708 and starts a bulk storage bootstrap process 706. After the bulk storage bootstrap process is complete, the operational node resets and goes into the power off state 702. During the flow process of FIG. 7, the operational node according to embodiments can be used to receive e-mail attachments from a server or other networked computer. The process involves transcoding the e-mail attachment from a first digital format to a second digital format comprising a visual image format in the operational node, loading pre-boot data and operating system software onto the operational node from a data store on the trusted node onto the operational node, and then rebooting the operational node to reboot to remove the pre-boot data and the operating system software from the operational node such that no rewrite functions are performed on the operational node.

As shown in FIG. 8, the time line for this process on the operational node goes from the off state to the firmware bootstrap step 802 and the bulk storage bootstrap state. This period is a safe update period 803 and continues until the bulk storage bootstrap stops and the application period starts 806. During the application execution period, the operational node is in a possible infection period 805. The illustration of FIG. 8 shows an example in which the operational node is actually infected 808 during the possible infection period. The reset step 810 that powers off the operational node, however, initiates an infection destruction period 807 in which the malware attack is eliminated.

Optional embodiments of the present invention may broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments is not intended to be exhaustive or to limit the embodiments to the precise form or instructions disclosed. While specific embodiments of, and examples are described herein for illustrative purposes, various equivalent modifications are possible within the scope of the disclosed methods and structures, as those skilled in the relevant art will recognize. The elements and acts of the various embodiments described above can be combined to provide further embodiments.

In general, in the following claims, the terms used should not be construed to limit the disclosed method to the specific embodiments disclosed in the specification and the claims, but should be construed to include all operations or processes that operate under the claims. Accordingly, the disclosed structures and methods are not limited by the disclosure, but instead the scope of the recited method is to be determined entirely by the claims. While certain aspects of the disclosed system and method are presented below in certain claim forms, the inventors contemplate the various aspects of the methodology in any number of claim forms. For example, while only one aspect may be recited as embodied in machine-readable medium, other aspects may likewise be embodied in machine-readable medium. Accordingly, the inventors reserve the right to add additional claims after filing the application to pursue such additional claim forms for other aspects.

What is claimed is:

1. A method for securing firmware from malware in a computing system having a trusted node connected to at least one operational node, comprising the steps of:
sending a power up signal from the trusted node to the operational node when it is desired to utilize the operational node for computer processing purposes;
requesting from the trusted node pre-boot data from the operational node; and
sending pre-boot data from the trusted node to the operational node.

2. The method of claim 1, further including the steps of:
sending operating system software from the trusted node to the operational node; and
loading the sent operating system software sent from the trusted node on the operational node.

3. The method of claim 2, further including the step of upon completion of the desired computer processing on the operational node, the trusted node causes the operational node to reboot to remove the pre-boot data and the operating system software from the operational node such that no rewrite functions are performed on the operational node.

4. The method of claim 3, further including the step of upon rebooting the operational node terminating power to the operational node upon a command from the trusted node.

5. The method of claim 1, wherein the trusted node is a daughterboard and the operational node is a motherboard.

6. A system for securing a computer environment from malware, the system comprising a trusted daughterboard coupled to an operational motherboard wherein the trusted daughterboard is operative to reset the operational motherboard into a trusted state.

7. The system of claim 6 wherein the trusted daughterboard is operative to manage the state of the operational motherboard.

8. The system of claim 7 wherein the trusted daughterboard is operative to manage the state of the operational motherboard using bootstrapped information.

9. The system of claim 8 wherein the bootstrapped information is obtained from the internet.

10. The system of claim 6 wherein the trusted daughterboard is coupled to a plurality of operational motherboards.

11. The system of claim 6 wherein the operational motherboard and said trusted daughterboard are coupled via a gigabit Ethernet interface.

12. The system of claim 6 wherein the operational motherboard includes an x86 processor system.

13. The system of claim 6 wherein the operational motherboard includes an x86 compatible processor system.

14. The system of claim 6 wherein the operational motherboard is coupled to an IP KVM (Internet Protocol Keyboard/Video/Mouse) component for receiving input commands and sending output signals.

15. The system of claim 6 wherein the operational motherboard further includes a BIOS capable of netbooting and bootstrapping data.

16. The system of claim 6 wherein the operational motherboard includes a plurality of micro-controllers.

17. The system of 15 wherein the operational motherboard further includes net firmware and a boot store wherein the BIOS and the net firmware are coupled to the boot store.

18. The system of claim 17 wherein the boot store is in operative communication with the trusted daughterboard.

19. The system of claim 18 wherein a gigabit Ethernet connects the boot store to the trusted daughterboard.

20. The system of claim 18 further including a Gigabit Ethernet switch coupled intermediate the trusted daughterboard, the operational motherboard and an IP KVM component coupled to the operational motherboard.
